(19) United States
(12) Patent Application Publication
(10) Pub. No.: US 2016/0335350 A1
(43) Pub. Date: Nov. 17, 2016

(54) COMPUTER IMPLEMENTED METHOD FOR RANKING, SEARCHING AND MANAGING CONTACTS IN ELECTRONIC DEVICE

(71) Applicants: Vinay BAWRI, Ballygunge (IN); Ritesh BAWRI, Ballygunge (IN); Malvika BAWRI, Ballygunge (IN)

(72) Inventors: Vinay BAWRI, Ballygunge (IN); Ritesh BAWRI, Ballygunge (IN); Malvika BAWRI, Ballygunge (IN)

(21) Appl. No.: 15/153,307

(22) Filed: May 12, 2016

(30) Foreign Application Priority Data
May 13, 2015 (IN) 1170/KOL/2014

(51) Int. Cl. G06F 17/30; H04M 1/2745

(52) U.S. Cl. CPC G06F 17/30864; H04M 1/274533; H04M 1/274583; G06F 17/3053

(57) ABSTRACT

Disclosed is a processor based system and method for ranking, searching and managing contact information of a contact database. The said contact information is ranked based on various criteria, such as, who knows whom, similarity of interests, proximity of user devices, frequently dialed numbers, devices as well as simultaneously searching for similar information on the internet. The system and method also provides means for removing defunct contacts. Further, the system and method also provides mechanism by which the contact information is searched on external data repositories, such as the internet, when a desired contact is unavailable to the user.

### CROSS REFERENCE TO RELATED APPLICATIONS

This complete specification is filed in pursuance of the provisional Indian patent application numbered 1170/KOL/2014 filed at Indian Patent Office on 13 Nov., 2014.

### FIELD OF THE DISCLOSURE

The present disclosure relates to a computer implemented method and system for ranking, searching and managing contacts on a user's electronic device such as but not limited to a user's computing device, a GPS system and/or contacts present on a cloud storage linked with the user's electronic device.

### BACKGROUND OF THE DISCLOSURE

In present times, most of us carry a long list of contact information of our family members, friends, colleagues and other needed persons, on our mobile devices. Many of us store such long list of contact information manually and/or electronically in these electronic devices such as smart phones, or on cloud storage, or on our laptop and/or in other digital storage devices/services.

Managing the said long list of contacts is always a tedious task and there are different data parameters available to store and to manage the said contact information. The said data parameters include but are not limited to data parameter related to a home phone number, a work phone number, a mobile phone number, a fax number, a company name, an email address, a home address, a work address, a birthday date, an anniversary date, and/or a social network profile information of a person. People around the world rely on electronic devices such as a mobile phone, a personal digital assistance (PDA), or a computer to store and to organize information about their contacts.

Now a days, mobile phones and/or PDAs have become ubiquitous. When a user of a mobile phone wants to call/talk another person then the user has to launch the contact application of his/her mobile phone. Firstly, the user has to select a phone contact number of such another person as present on the contact application of the user's mobile phone, and then the user dials this selected contact number of another person. Alternately, if the said contact number of another person is not present in the user's contact application, then the user has to launch the contact application, and to provide an input of such contact number of another person and then to dial the said inputted contact number. As most of the users store thousands of entries in their address book, the user has to spend time on the tedious task of entering, updating, and searching for the desired contact information. It is the specific technical problem in the computing world that the present disclosure wishes to address.

Moreover, sometimes the contact application of the user's mobile phone does not have the desired contact phone numbers or contact addresses of another person. In such a situation, the user might have to call other friends/persons for such desired contact phone number, or the user has to perform an internet search for finding out the desired contact information. The internet search comprises launching an internet browser, entering a query containing search terms, searching for the desired contacts information, and then perhaps dialing the desired contact number. It is a time consuming a tedious task in the computing world, and is a technical problem which is required to be addressed.

The search terms as provided herein by the user for searching the relevant content are used to locate the relevant information from a database present on a remote server or on an electronic device. The search results are provided to the user in the form of query results and/or URL's. A user then browses through these query results until the user finds the desired information related to the said desired contact addresses or phone numbers. If at the first attempt the user does not find such desired information, then the user might try another query or may give up looking for the desired contacts information on the internet. This is another tedious task in the computing world, and is a technical problem which is required to be addressed.

### SUMMARY OF THE DISCLOSURE

In view of the foregoing disadvantages inherent in the prior-art and the needs as mentioned above, the present disclosure provides a processor implemented method system for ranking, searching and managing contacts on users' electronic devices and services.

In order to overcome these problems or limitations, the present disclosure provides a processor implemented system and method so that a user can easily fetch the required contact information/number as well as the contact address and other required details of a person from multiple sources such as but not limited to contact book of another person, internet searching, social media accounts and/or cloud storage of contacts.

Moreover, the processor implemented system and method of the present disclosure applies to contact lists and/or address books stored on the contact applications of the mobile phones, tablets, desktops, laptops, in the cloud, on a remote server, on a smart watch, on Instant Messenger clients like Skype™ and others, on short messaging service clients, on drop box, and on other electronic devices and services. The system and method of the present disclosure dynamically updates a database which stores and analyzes information on contacts.

Moreover, the present processor implemented method is adapted to automatically search for the desired contact information over the internet and provide such information to the user. Further, the present disclosure proposes an intelligent system and method adapted to automatically locate the required contacts details such as mobile phone number, etc., and provide such details to the user via the said electronic devices and services.

To achieve the above objectives and to fulfill the identified needs, in one aspect, the present disclosure provides a processor implemented method or system for searching contacts information from a database such as an online database or an offline database. The search results are ranked based on various criteria including but not limited to; a) the number of people/contacts, b) the user and the contact known in common, c) the degree of separation between two or more of the user's contacts, d) whether the user and the contact attended the same education institution and/or worked at the same company, e) the social groups the user and the contact have in common, f) the similarity of interests between the user and the contact, and g) the proximity of the user's electronic device with the other users' electronic devices, etc. It should be understood that these are only exemplary criteria.

The present computer implemented method includes receiving at least one search term from the user over a contact search interface of the user computing device. The said at least one search term as provided herein is selected from at least a text, a numeral, a word, an alphabet, a special character, a text, a sign, an alphanumeric, an audio input, a braille characters and/or a combination thereof. Further, based on the user's geo location, the said search term can be detected as the geo location of the user and entered as a search term in the user's electronic device. Let us say that the user is in a certain neighborhood i.e. Dallas. In this case, the user's electronic device detects that the user is present in the Dallas neighborhood and a geo-tag is provided to the user's electronic device. Based on such user's geo tagging, the electronic device of the user detects the search term as “Dallas” and automatically enters “Dallas” as a search term in the background and retrieves contact information for the user's contacts that lives in the “Dallas” neighborhood. The said at least one search term is intended to search and identify one or more contacts from the plurality of contacts as stored on a contact database. The said contact database is an online database or an offline database.

Once the search term is received, the present processor implemented method conducts a search in the said plurality of contacts in relation to the received search term. Thereafter, the present processor based system and method generates at least one closeness point for each of the said plurality of contacts. The said closeness point is based on at least one communication activity related to such plurality of contacts. Further, the said closeness point is based on various parameters including but not limited to the most frequently dialed numbers, the time when the call was placed, the location from where the call was placed, the last few numbers that were dialed, frequently dialed numbers and frequently used email addresses. These parameters are helpful in determining the closeness point of a contact and thus find out those contacts which the user actually requires at a particular time and place. Moreover, a user can also generate and select his own closeness point based on his choice and usages.

Once the search is complete, the present processor based system and method retrieves and ranks the said plurality of contacts. This ranking is based on at least one said closeness point. The contacts with high level of closeness points are ranked at a higher position and shown first in the search results and the contacts with low level of closeness points are ranked at a lower position and shown toward the end of the search results. Hence, according to the ranking provided by the present system and method, each contact is placed and presented in the contact list of the electronic device or an electronic service. Thereafter, the said ranked contacts are sorted and displayed to the user on the said electronic device.

In yet another aspect of the present disclosure, the processor based system and method of the present disclosure provides an innovative contact manager for the user's electronic device. The said innovative contact manager is adapted to automatically delete the defunct contact numbers by validating through web directories as well as audio feedback which the user received while dialing a number.

In yet another aspect of the present disclosure, the processor based system and method provides a third party contact to the user. The third party contact is a contact of a third person which is not present in the user's contact book or a missing contact of an unknown/know person which user wants to retrieve and communicate. The present disclosure is adapted to automatically search the web and present the third party contact to the user, including information related to the third party contacts as well as location of such third party, and information like driving directions for connecting the user with the said third party.

In yet another aspect of the present disclosure, the contact manager is adapted to share some part of the contact directory within an authorized group of users. The said part of the contact directory is shared via a wired or wireless communication mean such as but not limited to instant messaging (IM), short message service (SMS), email, Bluetooth, Wi-Fi etc.

In yet another aspect of the present disclosure, the contact manager is adapted to provide a name to an unknown contact appearing on the user's electronic device. In some situations, the user enters a contact number in the contact book of the electronic device but forgets to assign a name to said contact number, or a contact number is usually called by the user but not assigned with a contact name, or an unknown number make a call to the user where the user does not know the name of such contact. In such situations, the contact manager implemented on the electronic device will collect the name related to that contact number from online or offline contact databases and assign the name to the said contact number. Accordingly, the contact manager dynamically provides a contact name to a contact number.

In yet another aspect of the present disclosure, the system and method of the present disclosure provides a pre-loaded directory onto the user's electronic device. The pre-loaded directory includes all user desired contacts which are used in day to day life such as emergency number, airline reservation number, ambulance number, nearby restaurant number and the like.

In yet another aspect of the present disclosure, the contact manager is adapted to avoid input time for an IVR (Interactive Voice Response) enable reservation or helpline numbers and other similar contact numbers. Whenever, the user dialed an IVR enabled number, contact manager saves an input provided by the user for next time. Next time, if the user dials the same number, contact manager automatically provides an input to the IVR and connects the user with the desired section or the person.

In yet another aspect of the present disclosure, the contact manager provides at least one alternate contact number for a dialed contact number in case the dialed contact number is busy or out of service. The said alternate contact number is provided only when and if said alternate contact number is available on an online or an offline contact database. This process is helpful in saving the users valuable time of manually searching and finding the alternate contact numbers of the person, whenever, the dialed contact numbers show busy or out of service status.

In yet another aspect of the present disclosure, the contact manager implementable on the user's electronic device is adapted to directly post updates on social network sites such as Facebook, LinkedIn, or Twitter on special dates like birthdays, anniversaries related to various contacts of the user. The pre-formatted message can be an email, a birthday card or a greeting card or any other similar expression. The user can select different pre-formatted messages for different groups of contacts such as different message for school friends, different message for relatives, different message for elders, and different messages for juniors. The contact manager is adapted to automatically choose an appropriate birthday card from the user's electronic device. If the said birthday card is not present on the said user's electronic device, then the contact manager searches the World Wide Web to find out an appropriate birthday card. The said birthday card is selected based on number of factors such as but not limited to the age of a particular contact, the level of closeness of the contact to the user, and which distribution list or group the contact belongs to. Hence, the present disclosure provides a very convenient means of greeting friends and thus saves a lot of time of the user.

The various aspects of the present disclosure are not limited to the phone or a handheld electronic device. Moreover, the various aspects of the present disclosure can be applied to any database such as contact list on mobiles, tablets, personal computers and other electronic device in addition to Skype database, contact list on Gmail, contacts on desktop and other similar databases. The contact list as defined in the present disclosure comprises a phone number contact list, email contact addresses, fax contact numbers, and other different groups of contacts.

These aspects together with other aspects of the present disclosure, along with the various features of novelty that characterize the present disclosure, are pointed out with particularity in the present description and form a part of this present disclosure. For a better understanding of the present disclosure, its operating advantages, and the specific objects attained by its uses, reference should be made to the accompanying drawing and descriptive matter in which there is illustrated an exemplary embodiment of the present disclosure.

### BRIEF DESCRIPTION OF THE DRAWINGS

The advantages and features of the present disclosure will become better understood with reference to the following detailed description and claims taken in conjunction with the accompanying drawing, wherein,

FIG. 1 illustrates a block diagram showing a configuration of an electronic device having a contact manager, according to an embodiment of the present disclosure;

FIG. 2 illustrates an algorithm as a flow diagram illustrating the ranking and presentation of the contacts based on a closeness element, according to an embodiment of the present disclosure;

FIG. 2(a) illustrates a block diagram showing a configuration of an electronic device and its various components, representations depicting how the contact manager provides ranking based on closeness element and shows results on a user's screen, according to an embodiment of the present disclosure;

FIG. 2(b) illustrates a block diagram depicting the ranking and presentation of the contacts based on a closeness element, according to an embodiment of the present disclosure;

FIG. 3 illustrates an algorithm as a flow chart of a contact manager deleting a defunct phone number from a phone book, according to an embodiment of the present disclosure;

FIG. 4 illustrates an algorithm as a flow chart of a contact manager removing duplicity from a phone book, according to an embodiment of the present disclosure;

FIG. 5 illustrates an algorithm as a flow chart of a contact manager providing contact details from the internet, in case a contact is unavailable in a phone book of the user, according to an embodiment of the present disclosure;

FIGS. 6 & 6(a) illustrate an algorithm as an end to end flow diagram of the computer implemented process for searching, ranking the contacts of a contact book according to an embodiment of the present disclosure.

Like numerals refer to like elements throughout the present disclosure.

### DETAILED DESCRIPTION OF THE DISCLOSURE

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

The terms “a” and “an” herein do not denote a limitation of quantity, but rather denote the presence of at least one of the referenced item.

The terms “having”, “comprising”, “including”, and variations thereof signify the presence of a component.

The term “curating”, or “curation” of one or more contacts in a contact database, or variations thereof means adding, deleting, replacing or substituting one or more contacts in the database, in order to make the contact database more relevant for the user. Various examples of curation are given throughout the present disclosure.

The present disclosure provides a processor based system and method of searching, ranking and managing contacts on an electronic device of the user, as well as simultaneously searching for similar information on the internet and providing such information on the electronic device of the user. In another implementation, the present disclosure also provides an electronic device employing the processor implemented method for searching, ranking and managing contacts on the device.

It will be apparent to a person skilled in the art that the terms “searching and ranking” as used herein refer to an arrangement of various data elements in a specific configuration, searching the data and providing ranking to the searched data according to user's requirement. Usually, such process is implemented in a manner that the data or any other content is at one end and the server or processor is at a remote end. Further, it should be understood that although the present disclosure is shown and described to be applicable in a mobile phone, such explanation should not be construed as a limitation to the present disclosure. Accordingly, the method and systems disclosed may be equally applicable to any electronic device.

Further, the term “contact” as referred herein means a contact number, a contact address, or a contact name over the contact list of the user electronic or computing device. The user may also assign a real name or a nickname or a symbol or an image as the contact name. Further, it will be apparent to a person skilled in the art that one contact name may be assigned to a plurality of telephone numbers and data like email address, fax number, date of birth, links to social network profiles, for example Facebook™ and LinkedIn™ or any other field in the user's contact book and the fields are not limited to the ones mentioned.

The term “contact list” as referenced herein refers to a list of one or more contact names, preferably stored in the electronic device of the user.

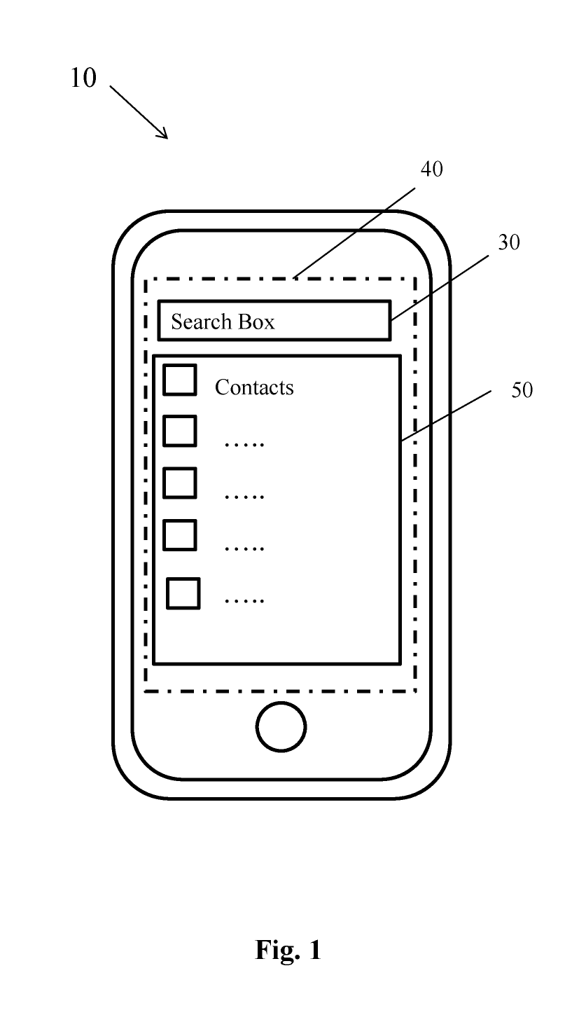

The processor implemented system and method of the present disclosure will now be explained in conjunction with FIGS. 1-5 as below. Also, disclosed is an electronic device employing the processor implemented system and method of the present disclosure.

Now referring to FIG. 1, there is shown a block diagram for an electronic device 10 as per various embodiments of the present disclosure. The electronic device 10 as shown herein includes a user interface (UI) 40 having a contact list 50 in conjugation with a search interface 30. The user enters a search term in the contact search interface 30. Thereafter, the contacts are ranked and shown in the hierarchy pattern over the contact list 50. If the desired contact is not found in the contact list 50 of the electronic device 10, then the desired contacts are retrieved from the web and displayed on the user interface (UI) 40 of the electronic device 10. The entire process which implements the retrieval of contact based on a predefined set of parameters as described below will now be explained in detail.

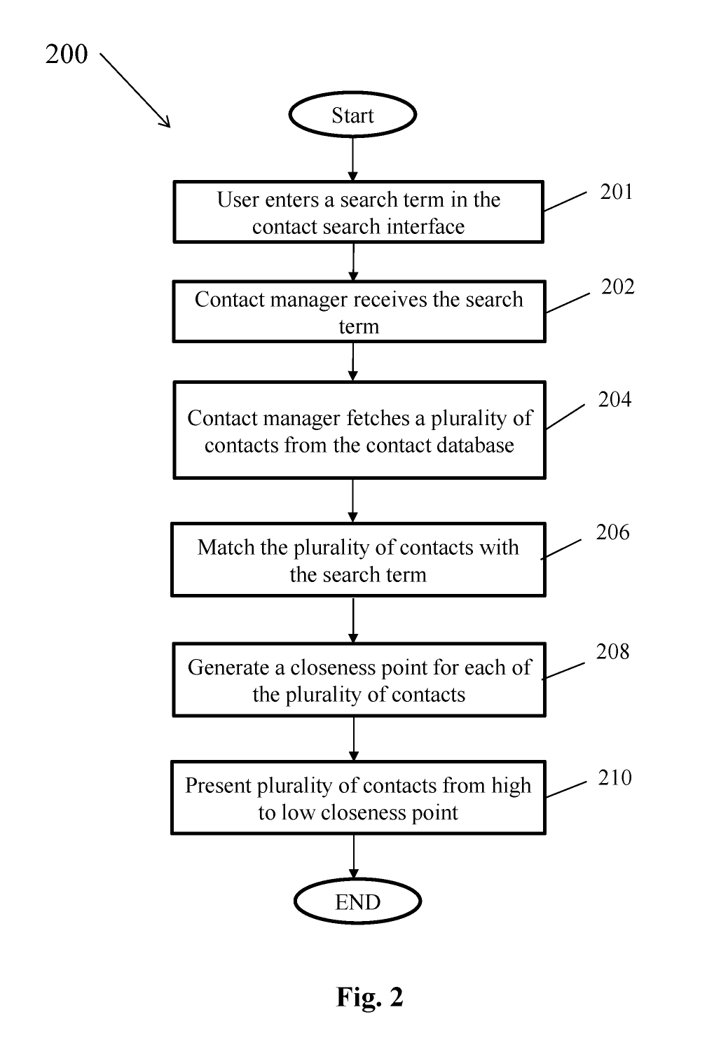

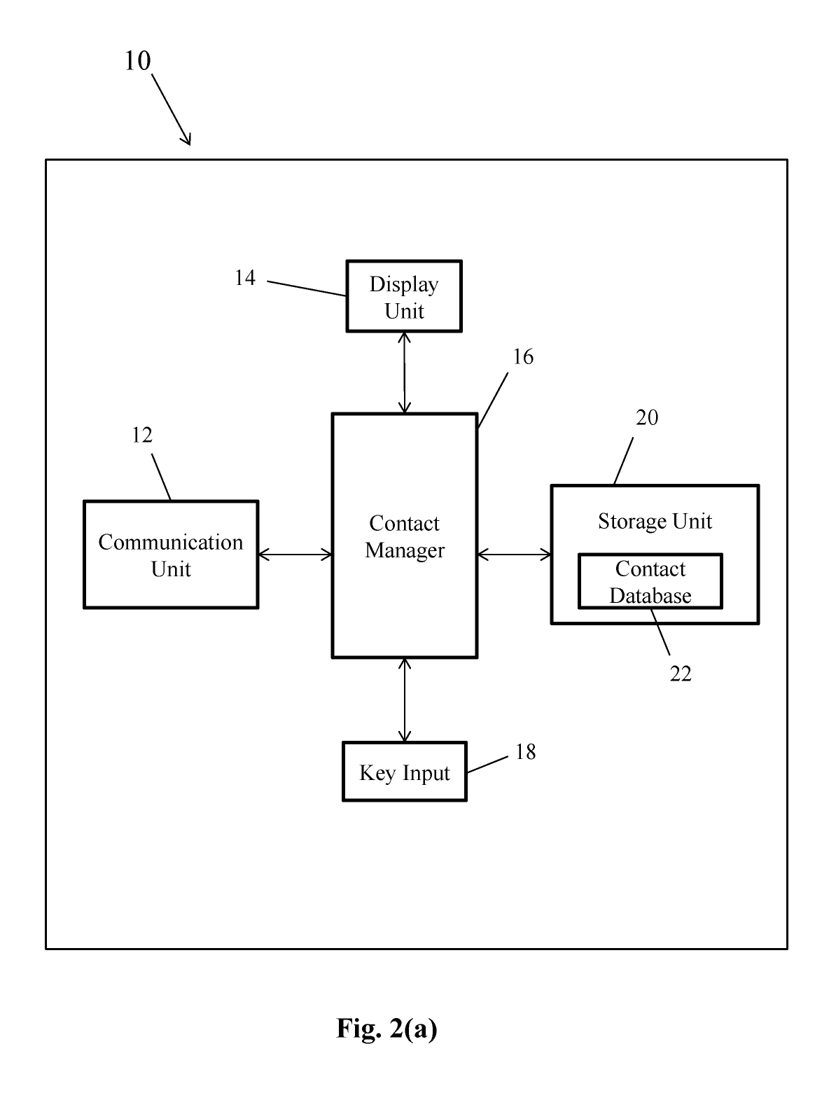

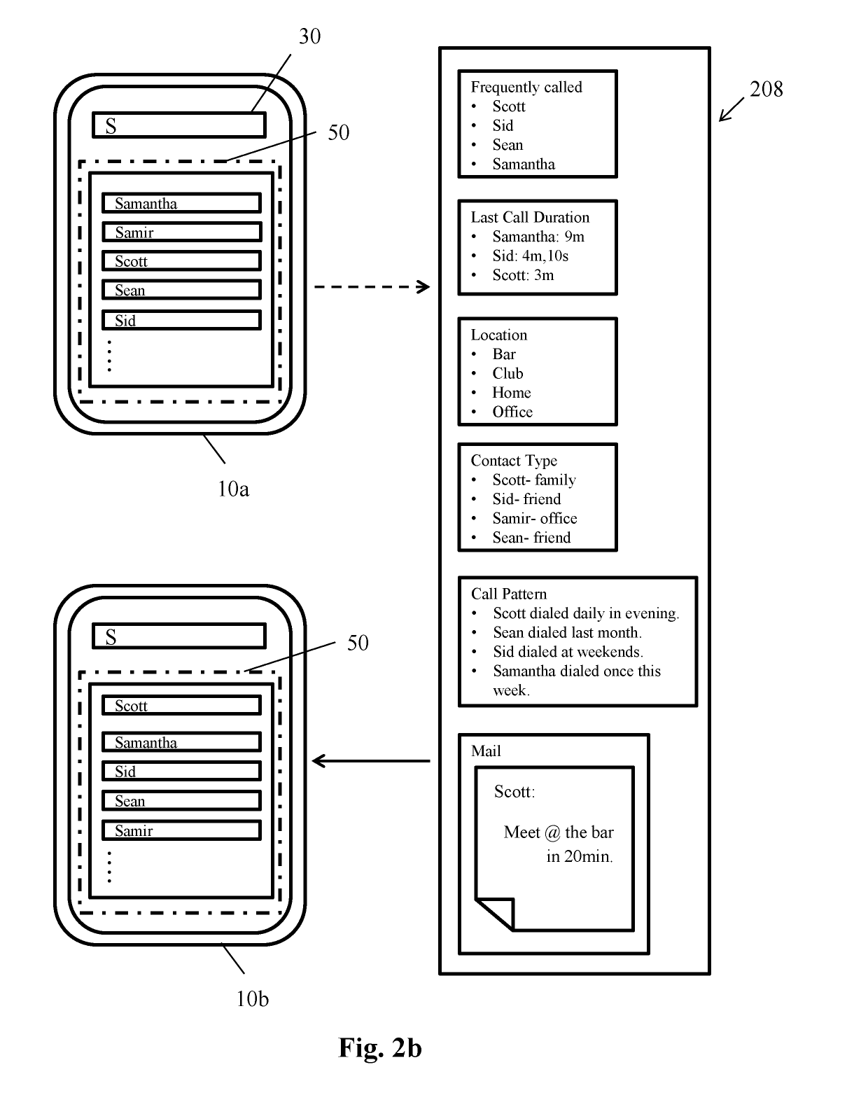

Now referring to FIG. 2, there is shown an algorithm illustrated as a flow diagram illustrating the computer implemented method for searching and ranking results, according to various embodiments of the present disclosure. The method steps as shown herein are explained in conjunction with FIGS. 2(a) and 2(b).

In FIG. 2(a), there is shown a block diagram of an electronic device 10 (a non-limiting example of a computer) and its various components. The electronic device 10 includes a RF (radio frequency) communication unit 12, a display unit 14, a contact manager 16, a key input unit 18, and a storage unit 20. The RF communication unit 12 performs a voice communication function, a messaging function, and communication with the World Wide Web. The RF communication unit includes an antenna. The contact manager 16 is adapted to manage a phone book by controlling a phone book and operating programs stored in the storage unit 20.

Referring to the method 200 as explained in FIG. 2, at step 201, a user enters a search term through the key input unit 18. At step 202, the contact manger 16 receives the search term from the key input unit 18. At step 204, the contact manager 16 performs a search in the contact database 22 of the electronic device 10 and fetches a plurality of contacts. Thereafter, at step 206, the contact manger 16 matches the plurality of contacts with the search term and at step 208, the plurality of contacts are ranked on the basis of their closeness point. The contact manager 16 further uses parameters, such as time, location and last dialed numbers to further improve the searching and ranking of plurality of contacts. Thereafter, at step 210, the contact manger 16 sorts the said ranked plurality of contacts and shows them in the hierarchy pattern over the display unit 14.

The contact manager 16 generates closeness points corresponding to each of the plurality of contacts. In various embodiments, the closeness points are generated based on various parameters. The suitable non-limiting examples of such parameters include but not limited to communication history of the user, location of the user, time of calls, automatic reminder such as a most frequent dial number, and the like.

In an exemplary embodiment, the user can find a list of numbers recently dialed without the same number being repeated and MMS and SMS numbers being part of the list. This helps the user to quickly locate a number that he/she may want to dial from the list of numbers present on a contact list. Today, the contact list is available in the form of a call log on most devices like mobile phones, PDAs and the like. The contact list comprises each and every contact number, whether called or messaged, which is rarely required by the user. In some implementations, this embodiment can improve the field of human and computer interaction because the user can easily access the call log through a different menu present on his mobile phone.

Now referring to FIG. 2(b) which is an exemplary illustration of the method 200. FIG. 2(b) describes searching in a typical user computing device 10 and generation of closeness elements on the basis of communication activity. The suitable non-limiting examples of the communication activity includes communication history of the user, location of the user, time of calls, automatic reminder such as most frequent dial number, and the like.

At step 208, generation on closeness points is performed on the basis of communication activity of the user. For instance, if the user searches for a contact starting with “S” in his electronic device 10, then the results are presented in alphabetical order if the device is deprived of step 208, as shown in 10a of FIG. 2(b).

In an embodiment of the present disclosure, FIG. 2(b) describes the steps for searching, managing and ranking contacts when the user enters the search term “S” in the search box 104 of the device. The generation of closeness points is shown as 208 in FIG. 2(b), wherein the contact manager 16 of the device 10 identifies the user activity for the contacts with “S” letter. Among the various non-limiting parameters for communication activity, the parameters such as frequency, call duration, location, contact type, call pattern, and messages are considered.

The FIG. 2(b) shows devices 10a and 10b. Both these devices are one but at different instants. Device 10a is a starting instance of the method 200, and device 10b is a termination instance of the method 200.

In an embodiment, the first parameter of generating closeness points, step 208, is “frequently called”. The contact “Scott” tops the list of most frequently called contacts, hence, this contact will be presented to the user as top search result at step 210 if only the frequency of calling is considered.

The second parameter, last call duration parameter will rank Samantha at the top of the list as a contact containing letter “S” and highest call duration of 9 minutes. The third parameter is location; this parameter presents the contacts on the basis of proximity to the user. This parameter will be explained later in conjunction with other parameters when contacts are presented to the user. The contact type parameter defines the relationship of the contact with the user. In an embodiment, the “family” contact type is given higher priority.

The fifth parameter for the generating closeness points is call pattern. This is the call activity of the contact with the user. In FIG. 2(b), the call pattern parameter keeps Scott at the top seeing that he is dialed daily in the evening.

The sixth parameter is mail in step 208 of FIG. 2(b). The processor executable method 200 checks the mail activity of the user with his contacts. Here, the method 200 discovers about a meeting with Scott at the bar in 20 minutes from the mail sent. The method will then show Scott's contact at the top if the user types in “S” in the search box 104.

Accordingly, these parameters, individually and/or in combination thereof, will be considered for ranking the contacts. Say, the user frequently goes to a particular bar during the evening time for getting his drinks. Further, the user usually calls his friend “Scott’ from that particular bar for attending the party. Now, in case when the user is present at that particular bar and opens contact database 22 of electronic device 10 and enters “S”. The present method runs a search after generating closeness points and provides “Scott” at the top of the search results. During the generation of closeness points, the method identifies that Scott is called most frequently; also his family type is given priority in the family type parameter. Further, the user received a mail from Scott regarding a meeting in 20 minutes. The method identifies the time parameter and places the contact Scott at the top seeing that user usually calls Scott in the evening. Besides, the location of user is at “bar” and the method keeping all the parameters of step 208 in consideration ranks Scott at the highest and presents it to the user as shown in 10b of FIG. 2(b).

In one embodiment, if the desired contact is not found in the contact database 22 of the electronic device 10, then the desired contacts are retrieved from the World Wide Web and displayed on the display unit 14 of the electronic device 10. This information can easily be located for example by mining the number from a Google knowledge graph which has a summary of various things like company name, person name and/or group name etc. Thus, the present computer implemented method, in some implementations, improves the field of information retrieval because the present method dynamically updates a database which stores and analyzes information on contacts.

The closeness element generated in step 208 will now be explained by way of various examples. In an embodiment, the contact manager 16 is adapted to give high weightage and importance to those contacts which were dialed successfully as well as those contacts which remain un-dialed. Accordingly, at step 210 the contacts which have been dialed more number of times by the user will be shown higher in the rearranged contact list and those which have never been dialed will be shown lower in the rearranged contact list.

Further, according to various embodiments of the present disclosure, the contact manager 16 will provide a higher closeness element to a set of pre-defined numbers which were last dialed or received by the user within a pre-defined time period. For example, the contact manager 16 may list the last 5 numbers which were dialed or received in the last 24 hours by the user, and will display it higher in the rearranged contact list, at step 210.

In another example, the contact manager 16 may be adapted to generate the closeness points based on time of calls. For example, if the system finds that the user usually calls “Sam Spade” in the mornings or any such pre-defined time range and “Sam Singh” in the evenings, and if the user is using the electronic device in the morning hours, then the contact manager 16 may provide results from “Sam Spade” above “Sam Singh” even though it should be the other way round when checked alphabetically from left to right.

In an embodiment, the system and method of the present disclosure is adapted to assist the user to find out the right contact number based on the data from the last dialed numbers and thus guess the contact. For example, if the system and method finds out that the user has repeatedly called a particular number after a previous number or generally makes calls to a particular number from a particular GPS location, then the system gives preferences to these numbers in the contact list.

Similarly in another embodiment, the contact manager 16 will use location data to find the most likely match, at step 208. For example, if a user is at an airport, the contact manager 16 may identify the GPS co-ordinates of the location of the user. In such a situation, the contact manager 16 understands that the user is more likely to call a taxi service, and accordingly provides the taxi service number on top of the contact list, at step 210. In usual circumstances, it needs to be understood that these results are the “best guess” of the present system and method.

According to yet another embodiment, if a user is in a city other than his home city, then the contact manager 16 may understand that the user is more likely to call his contact(s) or friend(s) living in that city compared to the contacts of home city. Therefore, the contact manager 16 provides more weightage to the contact number associated with the nearby location and shows it first on the contact list, at step 210. In another implementation, more weightage is given to the contacts that were called more frequently the last time when user was in that particular city.

In various embodiments, the contact manager 16 deals with contacts with multiple phone numbers in each contact. In other words, the contact manager 16 is intelligent enough to prioritize the numbers/information and present the most likely match to the user. According to various embodiments of the present disclosure, in a situation when there are two entries for the same contact “Sam” and the user enters the search “Sam”, the contact manager 16 will first find an exact match for “Sam” as this is a new facility for phone searches as provided by the present disclosure, and then provide the phone number/email address/information which has either been most frequently dialed by the user or has been last dialed or received. Thereafter, the contact manager 16 will allow a display of the contact, at step 210, which were dialed lately such as contact dialed a while back, and finally those contact which never dialed.

In various embodiments of the present disclosure, if there are multiple phone numbers for a contact then the contact manager 16 may give those numbers more importance which had been dialed successfully in the past. Further, the contact manager 16 gives weightage to different types of communication protocols in varying degrees. For example, the contact manager 16 ranks SMS lower than telephone numbers. Further, the contact manager 16 has different menus with lists, like call log, dialed call, frequently called, and like for phone numbers, SMS, MMS, and other types of communication. Accordingly, the contact manager 16 displays the contacts to the user, at step 210 of FIG. 2.

In another embodiment of the invention, a contact may have multiple numbers, like a land line, multiple mobile numbers like new and old numbers, a residence number etc. Whenever the user searches for a contact, the system ranks the numbers based on a) which one among the various numbers was recently dialed or a call received from b) whether they were dialed or received successfully by looking at the duration of the call (c) whether certain numbers of the contact are dialed at a particular time of day or location of the user (d) whether any contacts have not been successfully dialed a number of times. In this way, in some implementations, the system improves the field of human and computer interaction because the system prioritizes multiple numbers of the same contact and provides that contact number related to the user's requirement. The system can also automatically prompt the user to try an alternate number, if the main number is busy.

In an embodiment of the present disclosure, the contact manager 16 also acts as an automatic reminder for various tasks in the user's day to day life. As per one embodiment, if the system finds a particular periodicity like a week, month, two weeks, and the like, within the calling pattern of the user, then the contact manager 16 marks the instance, and informs/reminds the user, at step 210. For example, if a person calls on a number {(123)-456 7890} every Monday, then the contact manager 16 shows that number at the top of the results on each Monday. Another example, a person may call up his mother on a particular time of the day or week repeatedly.

In yet another aspect, the contact manager 16 is adapted to avoid multiple inputs at a time for an Interactive Voice Response (IVR) enabled reservation or helpline numbers and the like. In this aspect, whenever user dials an IVR enabled service number, the contact manager 16 saves the input in the storage unit 20 provided by the user for that particular number. Accordingly, the next time whenever user dials the same number, the contact manager 16 automatically provides an input to the IVR and may connect the user to desired section or the person, or may display to the user the combination that the user last used, when dialing this number and getting the IVR. Accordingly the present system and method can improve the field of human-computer interaction by saving time during future calls.

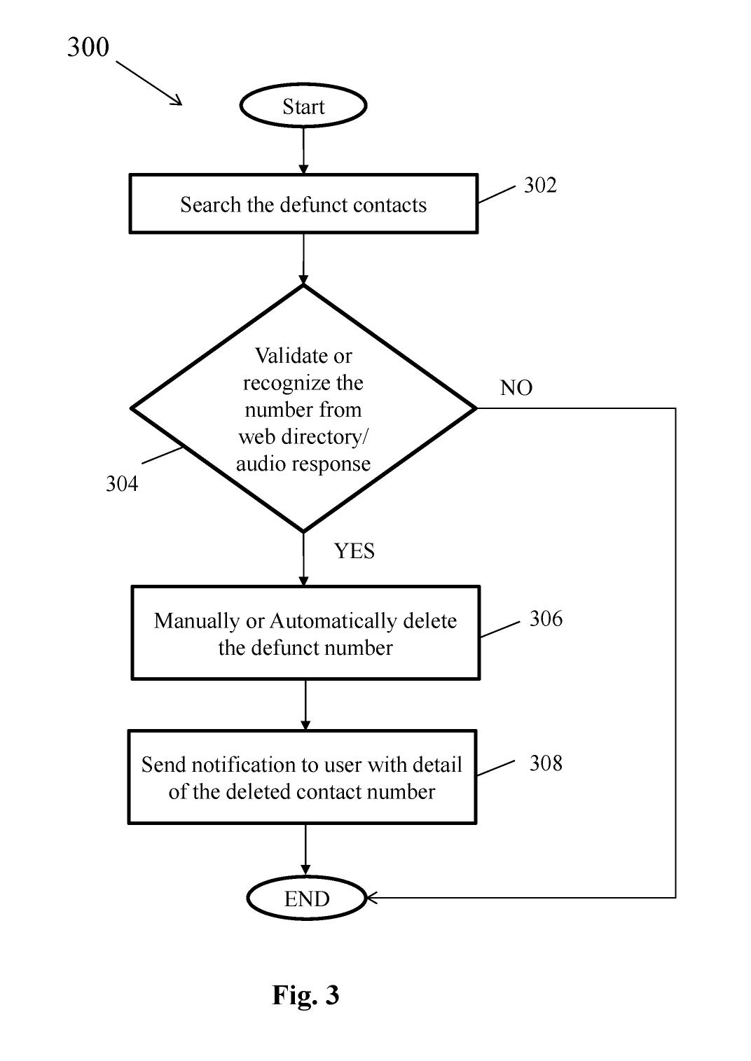

In another aspect, as shown in FIG. 3 which illustrates an algorithm as a flow chart, the present disclosure provides a method 300 for deleting and recognizing defunct numbers from the contact book. As per various embodiments, the user may delete defunct numbers manually or automatically depending on the user's requirement.

As per various embodiments of the present disclosure, as shown in FIG. 3, at step 302 the contact manager 16 fetches the contact list, which is pre-stored in the electronic device 10 of the user. Thereafter, the system and method of the present disclosure perform a search for recognizing and deleting the defunct contact numbers. The search of the defunct contact may be based on predefined criteria. Various predefined criteria will now be explained in detail.

As per the pre-defined criteria, the contact manager 16 identifies defunct numbers based on preset call duration. For example, the contact manager 16 recognizes the calls which don't last more than 10 seconds or the calls that never connect. Such phone numbers are given lower ranking in the defunct contact list. After ranking the numbers in the defunct list, the contact manager 16 performs validation or recognizing at step 304. At this step 304, the contact manager 16 validates contacts from web directory or from audio response during a call. At step 304, if the number is validated as a defunct number, then the method flows to step 306. Thereafter, the system prompts the user to manually delete the particular phone number of the contact or delete it automatically. If deleted automatically, then the user is notified about the deletion with details at step 308. At step 304, if the number is not validated as defunct, then method ends. For example, whenever, the user dials a defunct number, the system and method searches for an audio response such as “no longer in service” and thus validates the redundancy of the defunct number.

Moreover, if the contact database of user's device 10 contains some longtime unattended contact numbers or inactive contact numbers then the validation step determines that such contact numbers are in operation or not. If such contact number is not in operation, say “no longer in service” then this number will be automatically deleted. And if such contact number is in operation then the validation step will ask the user to delete or not to delete the number.

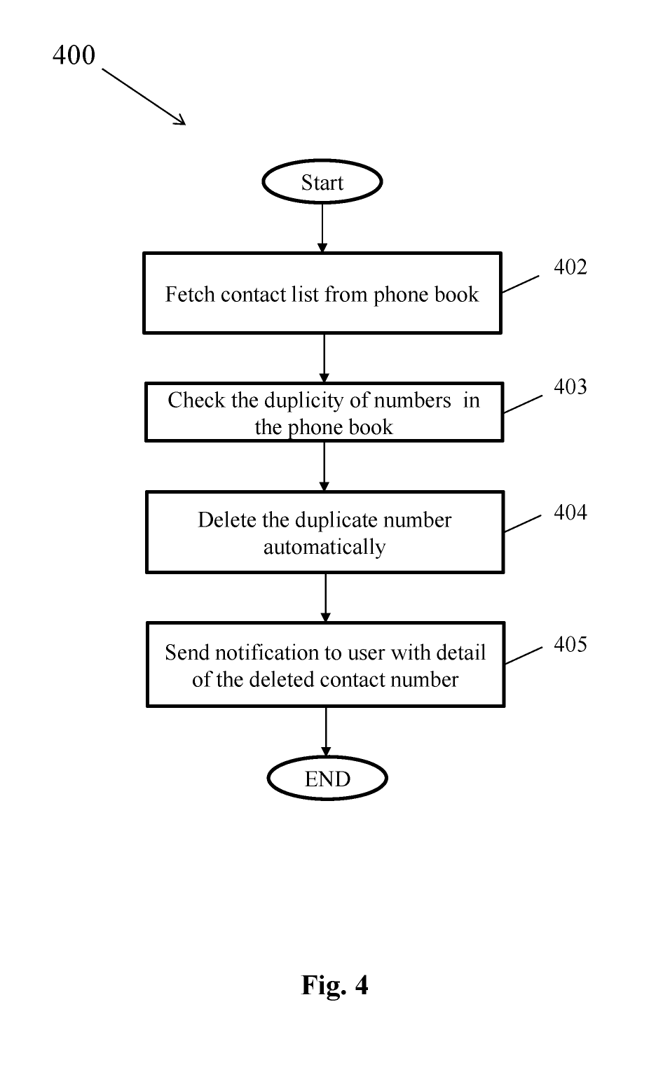

Now referring to FIG. 4, which illustrates an algorithm as a flow chart of a contact manager for removing duplicity from a phone book. The method starts at step 402, where the contact manager 16 fetches the contact list from the contact database. Then, at step 403, the contact manager 16 checks for the duplicity of the contact number and at step 404, the contact manager deletes the duplicate contact number. At step 405, the contact manager 16 sends such information of removing the duplicate number to the user.

In another aspect, the present disclosure provides a means for sourcing contact information in case the contact information is unavailable on user's electronic device. It has been observed that many times a desired phone number or address is unavailable in the user's phone book and/or contact list 50.

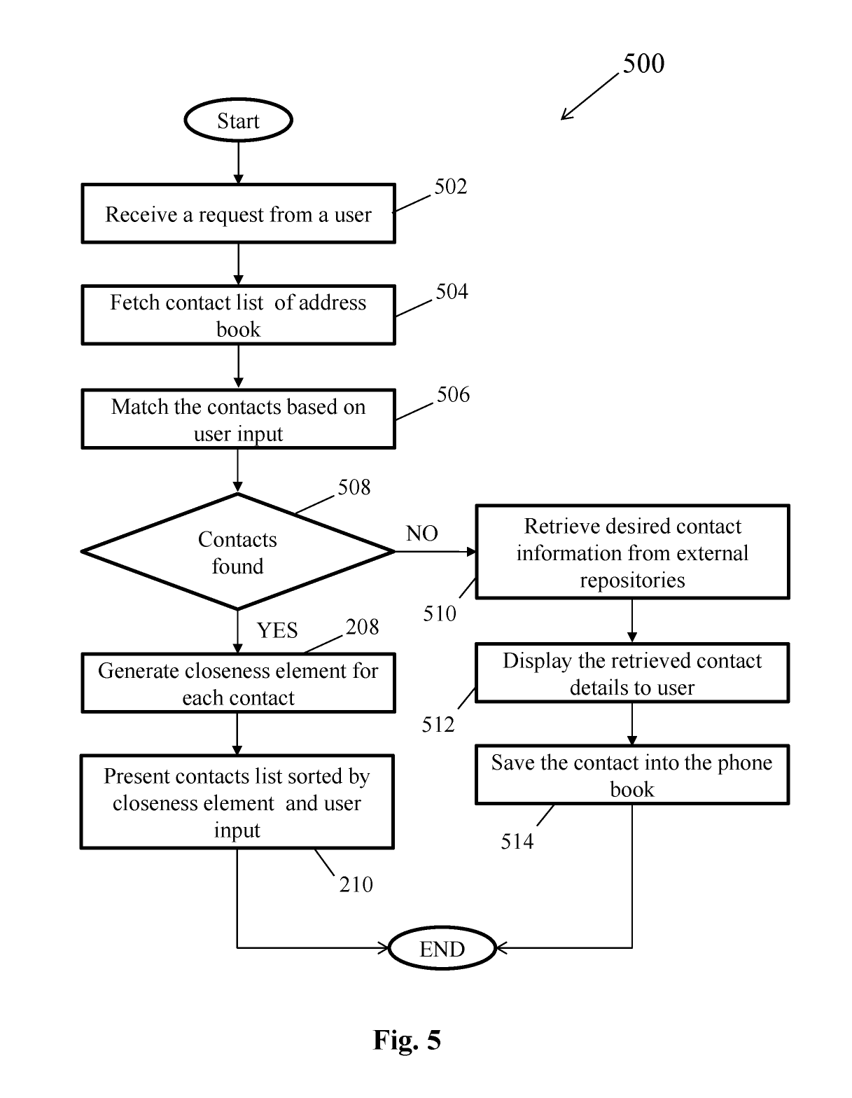

To solve the aforesaid problem, the present disclosure provides a method and system for providing contact details from various external sources, such as the internet. An exemplary implementation of a method for fetching contact details is shown with reference to method 500 of FIG. 5, which illustrates an algorithm as a flow chart of a contact manager providing contact details from the internet.

As illustrated in FIG. 5, the contact manager 16 receives a search request about a contact from the user, at step 502. Thereafter, the contact manager 16 fetches the contact list from the contact database 20 stored in the storage unit 20, at step 506. Then, the contact manager 16 matches the contact to the search request, at step 506.

In this situation, if the contact manager 16 is able to find a contact corresponding to the search query then the method 500 flows to steps 208 and 210 of FIG. 2 to display the contacts to the user on the electronic device 10.

In case, the user is unable to receive any contact, the contact manager automatically or after having user's permission connects to external information repositories, such as a web server via communication unit 10, at step 510. The retrieved contact details are identified from the web server or from internet web directories and displayed to the user. The display on the user interface 40 may be in the form of message or pop up notification or other similar notification type.

In another embodiment of the present disclosure, the contact manager 16 may be adapted to retrieve various ancillary information of the desired contact, such as his/her email address, home address, driving directions to the address, fax number, and other similar information, on the UI 40. At step 512, the contact manager 16 displays the retrieved results to the user. Thereafter at step 514, the contact manager 16 manually or automatically saves the desired contact into the contact list 50, which can be used later by the user.

As per various embodiments of the present disclosure, the contact manager 11 may be configured to provide variety of functions.

In one embodiment of the present disclosure, the contact manager 16 helps in overcoming the waiting time whenever the user gets “busy signal” or “out of service” response for a dialed contact. In such a case, the contact manager 16 is adapted to provide an alternate number for the same contact by selecting the alternate number from the list of numbers as stored in the contact list of the user's device. This improves, in some implementations, the field of human and computer interaction because the embodiment precludes the need for the user to find alternative numbers for a contact in case one of the dialed numbers of the contact is unavailable.

In another embodiment, the contact manager 16 is adapted to provide contact information of services and establishments near where the user works or lives. Further, the contact manager 16 is adapted to provide various emergency numbers. The contact manager 16 is configured to automatically load these numbers, addresses and data on to the phone book of the user's device. So, in some implementations, this provision improves the field of human and computer interaction because, when the user requires these contact information then the user is not required to search it manually over the internet or any other similar source.

In another embodiment of the present disclosure, the contact manager 16 is adapted to retrieve contact information from the phone book of a known person/friend alternatively called as third party. Sometimes, it happens that the user wants to make a contact with a particular person/friend (let us say friend “B”) but the user's phone book does not have the contact number of that particular person/friend (i.e. friend “B”). It is more likely that the contact number of that particular person/friend (i.e. friend “B”) is present on the phone book of another known person/friend (let us say friend “C”). In such a situation, the user can ask another known person/friend (i.e. friend “C”) to share the contact of the particular person/friend (i.e. friend “B”). Accordingly, the contact manager 16 as provided in the present disclosure is adapted to share/retrieve contact information of a particular person on or from the contact book of another person provided the said another person permits such contact sharing.

For example, in various situations, the admin manager of a company may have the contact information of all the employees of the organization. The contact manager 16 is configured to make some part of the address book viewable to others within, say a closed users' group. This allows sharing of contact information between various electronic devices 10.

In another embodiment, the contact manager of the present disclosure is adapted to identify and automatically delete the defunct numbers based on the audio feedback during the call such as “the number is not in operation”, “the number is out of service” and the other similar kind of audio feedback. Further, the user is given the choice to select a specific audio feedback for identifying and automatically deleting the defunct numbers. The user can select the specific audio feedback as per the local language, regional language or any of the international language of his/her choice.

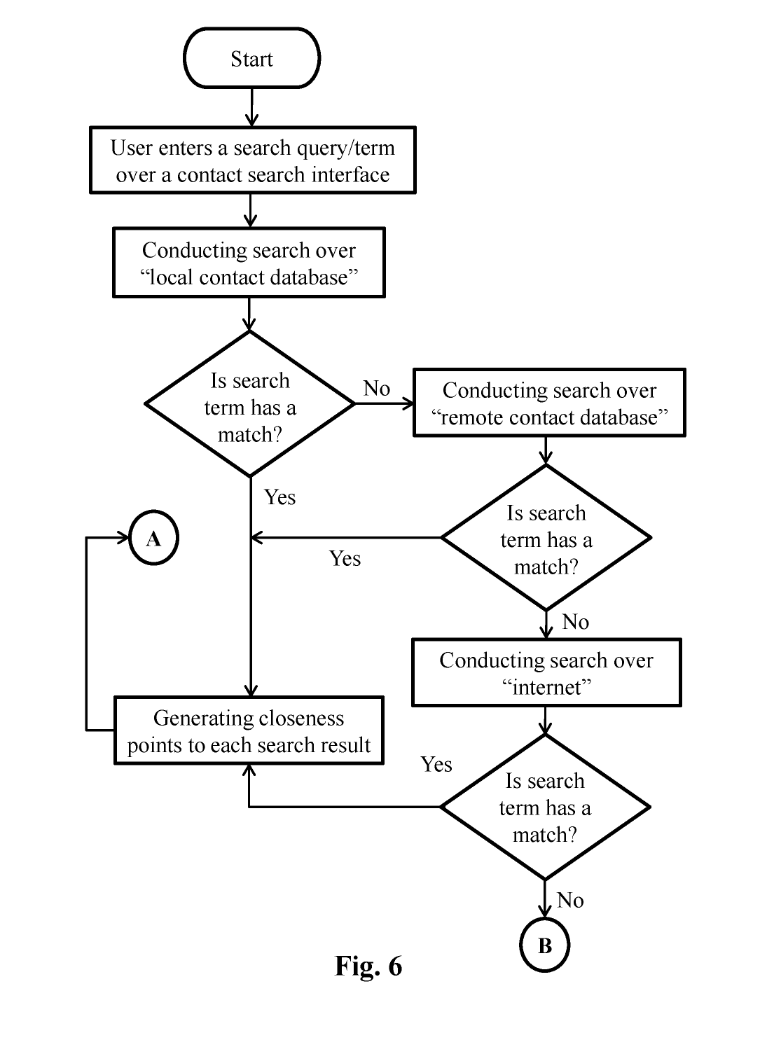

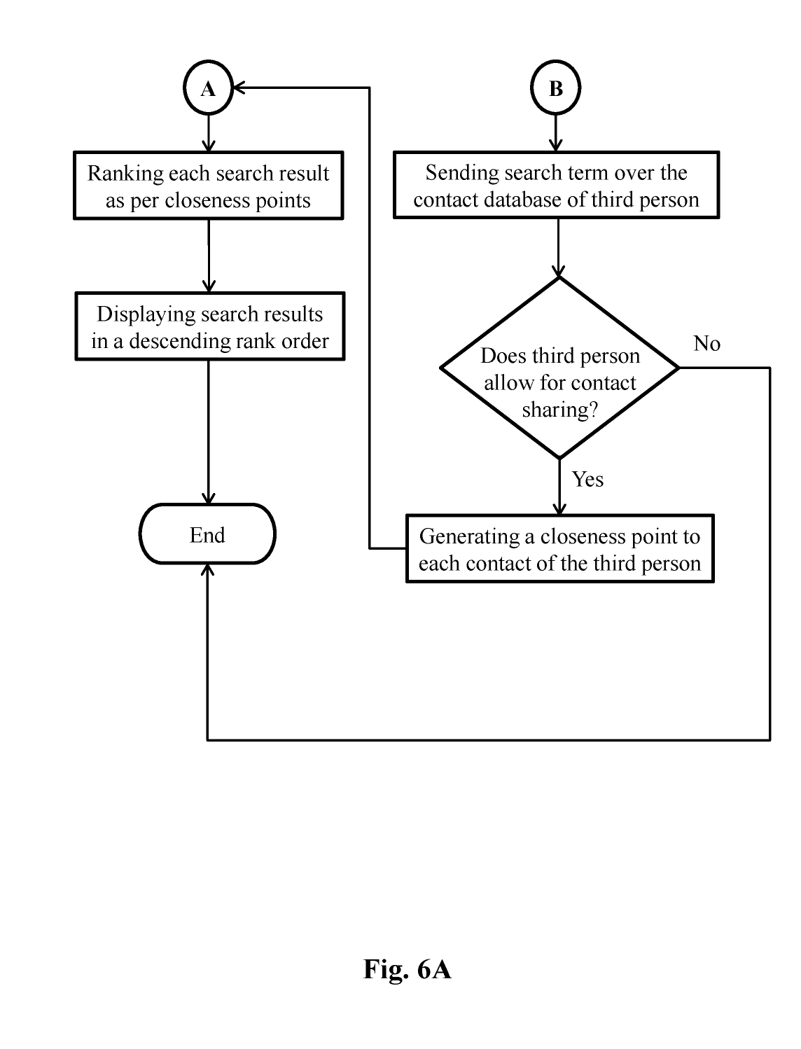

As illustrated in FIG. 6-6(a), illustrate an algorithm as an end to end flow diagram of the process and method for searching and ranking the contacts of a contact book as per the requirement of the user.

According to yet another embodiment of the present system and method, the electronic device 10 need not necessarily require user's search term to display the contacts but it is intelligent enough to provide the contacts on the basis of ranking. Say, usually when a user opens his dial pad in his electronic device 10, he is presented with frequently called contacts first. Here, the present system identifies various parameters such as closeness elements as identified in step 208 of FIG. 2, only this time the user is presented the ranked contacts without his input. This presentation of contacts without the user's input involves ranking of the contacts based on parameters like, frequently called, frequently called at a particular time, contacts in a particular geographical area, etc. among other ranking factors as disclosed in description above. In this way, the present method adapts and learns the user call behavior and provides him the contacts of his requirement without his input. Thus, in some implementations, the present computer implemented method improves the field of human and computer interaction because the method saves the user a lot of time.

Further, the present disclosure should not be construed to be limited to the configuration of the contact manager 16 as described herein only. Various configurations of the system are possible which shall also lie within the scope of the present disclosure.

The method, as described in the disclosed teachings or any of its components, may be embodied in the form of a computer implemented method. Typical examples of a computer included in the computer implemented method include a general-purpose computer, a PDA, a cell phone, a programmed microprocessor, a micro-controller, a peripheral integrated circuit element, and other devices or arrangements of devices that are capable of implementing the steps that constitute the method of the disclosed teachings.

In a computer implemented method using a general purpose computer, such a general purpose computer can include an input device such as a keyboard, a mouse, a trackball, a touchpad, a microphone, or a camera. The computer can include a display unit such as a projector, a monitor, or a touch screen. A touch screen can also be used as an input device. The computer can include a speaker. Specifically, the computer of the computer implemented method can comprise a microprocessor, where the microprocessor is connected to a communication bus. The computer of the computer implemented method can also include a memory, the memory may include Random Access Memory (RAM) and Read Only Memory (ROM). The computer of the computer implemented method can further comprise a non-transitory computer readable medium such as a storage device, which can be a hard disk drive or a removable storage drive such as a floppy disk drive, optical disk drive, and the like. The memory is also an example of a non-transitory computer readable medium. The storage device can also comprise other, similar means for loading computer programs or other instructions into the computer of the computer implemented method.

The computer of the computer implemented method can comprise an electronic device to communicate with a remote computer through a network. The electronic device can include a wireless communication port, a data cable connecting the computer of the computer based method with the network, and the like. The network can be a Local Area Network (LAN) or a Wide Area Network (WAN) such as the Internet and the like. The remote computer that is connected to the network can be a general-purpose computer, a server, a PDA, and the like. Further, the computer of the computer implemented method can access information from the remote computer through the network.

The algorithms described above may be embodied as sets of instructions stored on a computer readable medium which include various commands that instruct the computer of the computer implemented method to perform specific tasks such as the steps that comprise the methods and algorithms of the disclosed teachings. The sets of instructions may be embodied in the form of a transitory medium, such as a software program or a propagating wave. The software may be in various forms such as method software or application software. Further, the software might be in the form of a collection of separate programs, a program module with a larger program or a portion of a program module. The software might also include modular programming in the form of object-oriented programming. The software program or programs may be provided as a computer program product, such as in the form of a computer readable medium with the program or programs containing the set of instructions embodied therein. The processing of input data by the computer of the computer implemented method may be in response to user commands or in response to the results of previous processing or in response to a request made by another computer or mobile device.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present disclosure.

What is claimed is:

1. A computer-implemented method for searching, managing and ranking a plurality of contacts stored in a contact database in a user electronic device, the method comprising:
receiving at least one search term from the user over a contact search interface of the user computing device, the at least one search term intended to search and identify one or more contacts from the plurality of contacts;
searching the plurality of contacts in the contact database based on the said received search term;
retrieving the said searched plurality of contacts corresponding to the said received search term;
generating at least one closeness point for each of the said searched plurality of contacts, wherein, the closeness point is based on a predefined set of parameters related to the said searched plurality of contacts;
ranking the said searched plurality of contacts based on the at least one closeness point;
sorting the said searched plurality of contacts based on the ranking of the said searched plurality of contacts; and
displaying the said searched plurality of sorted contacts through the user computing device.

2. The computer-implemented method as claimed in claim 1, wherein the contact database comprises contact information related to the plurality of contacts in the form of a phone book, a contact directory, a contact book, and a contact list.

3. The computer-implemented method as claimed in claim 1, wherein the contact database is a local contact database present in the user electronic device or a remote contact database connected to the user electronic device via wired or wireless communication.

4. The computer-implemented method as claimed in claim 3, wherein searching the plurality of contacts from a contact database comprises:
searching the plurality of contacts over the local contact database; and
searching the plurality of contacts over the remote contact database, whenever searched contact is unavailable in the local contact database.

5. The computer-implemented method as claimed in claim 4, wherein, searching the plurality of contacts over the remote contact database comprises:
searching and retrieving at least one desired contact from the remote contact database, and
storing the said retrieved contact in the local database.

6. The computer-implemented method as claimed in claim 5, wherein the at least one desired contact is assigned a name based on the at least one search term received from the user computer device.

7. The computer-implemented method as claimed in claim 1, wherein searching the plurality of contacts comprises retrieving contact details by searching on the web.

8. The computer-implemented method as claimed in claim 1 further comprises curating one or more of plurality of contacts to determine a list of curated contacts.

9. A computer-implemented method for managing a plurality of contacts stored in a contact database in an environment having multiple user electronic devices, the method comprising retrieving the plurality of contacts stored in the contact database, curating one or more of plurality of contacts to determine a list of curated contacts, and storing the curated contacts in the contact database.

10. The method as claimed in claim 9, wherein curating one or more plurality of contacts comprises searching at least one junk contact from the contact database of the user electronic devices, and deleting the identified junk contacts.

11. The method as claimed in claim 9, wherein curating one or more plurality of contacts comprises
generating new contacts based on the Interactive Voice Response (IVR) history of the user computing devices, wherein the generated new contacts is used for automatically inputting a preset IVR response once an IVR based number is dialed by the user.

12. The method as claimed in claim 9, wherein curating one or more plurality of contacts comprises
sharing at least one contact between a first user electronic device and a second user computing device, and identifying unique contacts for each of the first user and the second user.

13. The method as claimed in claim 9, wherein curating one or more plurality of contacts comprises
determining at least one alternate contact in response to predefined signals when the at least one contact is dialed.

14. The computer-implemented method as claimed in claim 10, wherein the searching and deleting the at least one junk contact comprises:
searching the at least one junk contact from the contact database of the user computing device;
retrieving the at least one searched contact from the local contact database;
validating the said retrieved searched contact; and
deleting the said validated contacts from the local contact database of the user computing device.

15. The computer-implemented method as claimed in claim 10, wherein at least one junk contact is at least one of a duplicate contact number, a defunct contact number, and an inoperable contact number.

16. The computer-implemented method as claimed in claim 10, wherein searching the at least one junk contact is based on a pre-defined call duration or duplicity of the at least one contact.

17. The computer-implemented method as claimed in claim 14, wherein validating the said retrieved searched contact comprises:
validating the operational status of at least one contact stored in the contact database, or validating an audio feedback stored in the storage unit of the user electronic device, wherein, the audio feedback is an audio response signal disclosing the operational status of the at least one contact stored in the contact database.

18. The computer-implemented method as claimed in claim 11, wherein generating new contacts comprises storing the contact number and response data for the at least one IVR contact.

19. The computer-implemented method as claimed in claim 10, wherein sharing the at least one contact between first user electronic device and second user electronic device comprises:
sending a request of a desired contact from the first user electronic device to the second user computing device;
searching the said desired contact from the contact database of the second user computing device;
retrieving said desired contact from the contact database of the second user computing device; and
transmitting the said desired contact from the second user electronic device to the first user computing device.

20. The computer-implemented method as claimed in claim 13, wherein determining at least one alternate contact in response to a predefined signal of at least one dialed contact comprises:
selecting and dialing at least one contact from the user computing device;
receiving the predefined signal for the said dialed contact number, wherein the predefined signal comprises a busy signal, an out of service signal, number not in use, number does not exist, or a switched off signal;
identifying the said the predefined signal from the plurality of pre-stored notifications, wherein the pre-stored notification is in the form of at least a text message, a multimedia message, an audio feedback response, or a video feedback response and unavailable signal;
searching at least one alternate contact associated with the said dialed contact number; and
displaying the at least one alternate contact via the user computing device.
